(19) United States
(12) Patent Application Publication
(10) Pub. No.: US 2018/0258599 A1
(43) Pub. Date: Sep. 13, 2018

(54) DEVICE AND METHOD FOR REMOVING OF UNWANTED MATERIAL

(71) Applicants: Phillip Island Nature Park Board of Management Inc., Phillip Island, Victoria (AU); Victoria University, Footscray, Victoria (AU)

(72) Inventors: John Donald Orbell, Princes Hill (AU); Stephen William Bigger, Sunbury (AU); Lawrence Ngek Ngeh, Doncaster (AU); Matthew Lyndon Jackson, Murrumbeena (AU); Peter Michael Dann, Bass (AU); Bernard Agana, Deer Park (AU); David Roy Kay, Brighton East (AU)

(21) Appl. No.: 15/761,037

(22) PCT Filed: Sep. 13, 2016
(86) PCT No.: PCT/AU2016/050854

§ 371 Date: Mar. 16, 2018

(30) Foreign Application Priority Data
Sep. 16, 2015 (AU) 2015903770

(51) Int. Cl. E01H 1/14; E01H 12/00; E01H 1/00; B08B 1/00; B01J 20/02; B01J 20/18; B01J 20/28; B01J 20/30; C09K 3/32

(52) U.S. Cl. CPC E01H 1/14; E01H 12/006; E01H 1/001; B08B 1/00; B01J 20/0229; C02F 1/40; B01J 20/28004; B01J 20/28009; B01J 20/3085; C09K 3/32; B01J 20/186

(57) ABSTRACT

A collection kit for the removal of unwanted material from a surface, said kit comprising: iv) ferromagnetic material to absorb and/or adsorb the unwanted material when spread across the unwanted material creating an area of operation; v) an apparatus having a magnetic source operable to attract the ferromagnetic material together with absorbed and/or adsorbed unwanted material when the magnetic source is touching or in the vicinity of the area of operation; and vi) means to dislodge the ferromagnetic material and absorbed and/or adsorbed unwanted material from the apparatus once the ferromagnetic material has been removed from the area of operation.

### TECHNICAL FIELD

The present invention relates to a collection kit for the removal of unwanted material from a surface or a workplace. The kit itself includes an apparatus having a magnetic source and ferromagnetic material. In operation, the ferromagnetic material is adapted to be spread over the unwanted material so as to absorb and/or adsorb that material. The kit is operable to remove that material for disposal. The apparatus may be adapted for both domestic and/or commercial use. The unwanted material may be oils, fats, chemicals, paints, abattoir wastes, wine and other materials.

The present invention also relates to ferromagnetic material that has been specifically formulated for use with the collection kit. The ferromagnetic material of the present invention is formulated to be substantially lighter than iron powder alone, which makes it suitable for use with the preferred magnetic source apparatus.

The present invention also relates to a method for cleaning unwanted material from an area of operation which involves spreading the ferromagnetic material across the unwanted material such that the ferromagnetic material absorbs and/or adsorbs the unwanted material. The ferromagnetic material is attracted to the magnetic source, and may be disposed of once the magnetic source is withdrawn from the area of operation, or the ferromagnetic material is moved from the vicinity of the magnetic source.

### BACKGROUND OF THE INVENTION

Oil spills of varying descriptions are a common occurrence in an industrialised world. The form of an oil spill varies from the somewhat catastrophic, for example as the result of oil rig or tanker accident, to everyday occurrences in the workplace or home, to the somewhat minor that may be associated with personalised oil spills from automotive engines. The manner in which such oil spills are cleaned up to any degree also substantially varies depending upon the size of the oil spill, availability of appropriate technology and immediate consequences that may have resulted from such an oil spill.

When oil spills occur in a water environment, the oil forms a thick slick that floats on the water. The oil eventually spreads out, so it is paramount to contain it as rapidly as possible allowing skimming to occur to clean up the oil slick.

An unfortunate consequence that occurs when oil spills occur in such environments is that bird and sea life become coated with the oil slick. Where possible, bird life, including penguins, may recover if the oil is removed in a prompt enough manner.

Generally, such bird life may be washed with detergents to remove the oil. This has been found to be relatively effective although the use of detergents may also have a detrimental effect upon the bird life. Further, cleansing facilities are hard to transport to remote areas.

The use of ferromagnetic material, such as gamma-iron oxide or iron powder to assist in the cleaning of wildlife has been used where the ferromagnetic material is spread onto the oiled wildlife to absorb and/or adsorb the oil and then removed by the use of a magnetic wand to remove the ferromagnetic material from the bird together with the absorbed and/or adsorbed oil. The hand held magnetic device needs to be wiped clean to remove the oil laden ferromagnetic material. This has proven to be an effective means to clean wildlife affected by oil spills without the detrimental effects of detergents.

U.S. Pat. No. 389,024 describes a similar process where a polymer material is used, together with a ferromagnetic material, to provide additional absorption for the oil.

Whereas the use of ferromagnetic material and a hand held magnetic device have proven to be an effective means in which to clean oil from wildlife, such devices are not generally applicable to a broader range of situations where oil may be at issue, such as roads, home or in the workplace. Further, such devices have not been developed to clean up other types of unwarranted matter such as domestic or industrial cooking fats, paints, abattoir wastes and the like.

Other magnetic devices have been used to clean up metallic objects from roads and like surfaces, where a magnet may be swept over the surface to attract metal objects such as tacks, scrap metal or the like, that may have been spread over the surface. Such devices generally take the form of a trolley having a magnetic source as part of the underside carriage. These are adapted to attract metallic objects, and not adapted for use to clean up oil spills or the like.

It is a desired feature of the present invention to provide a magnetic collection kit that is applicable to a broad range of environments and situations, both domestically and on a commercial or industrial scale, where unwanted material such as oil spills and the like, needs to be removed and disposed of safely. Such devices may simultaneously pick up metal scraps.

It is a further desired feature of the present invention to provide a collection kit including a magnetic device that may be operated in a convenient manner where disposal of the unwanted material is relatively simple.

It is a further desired feature to provide a method for cleaning up unwanted material with a magnetic collection kit that is able to be applied to a variety of different environments.

It is a further desired feature to provide a ferromagnetic material that is formulated to be substantially lighter than iron powder yet still suitable for use with a magnetic device for the removal of unwanted material.

The present invention aims to provide a collection kit, including formulated ferromagnetic material suitable for use with the collection kit, and a method that meets these desired features.

A reference herein to a patent document or other matter which is given as prior art is not to be taken as an admission that that document or matter was known or that the information it contains was part of the common general knowledge as at the priority date of any of the claims.

Where the term “comprising” or variations thereof such as “comprises” has been used in the present specification, it will be understood to imply the inclusion of a stated integer or step or group of integers or steps but not the exclusion of any other integer or step or group of integers or steps.

### BRIEF DESCRIPTION OF THE INVENTION

The present invention relates to a collection kit that generally includes a magnetic source and ferromagnetic material that is able to absorb and/or adsorb unwanted material such as oil, fats and the like. The kit is generally operable when the ferromagnetic material is spread over the unwanted material to create an area of operation. The term, an area of operation as used herein is intended to refer to that area, such as a hard surface, where unwanted material such as oil and the like has spread. That is, the surface to be cleaned. The area of operation is created when the ferromagnetic material is spread over the unwanted material to absorb and/or adsorb that material. The collection kit is then able to remove the ferromagnetic material from the area of operation by the magnetic source. The attracted ferromagnetic material is then able to be dislodged from the magnetic source generally by removing the magnetic source from the vicinity of the ferromagnetic material, or removing the attracted ferromagnetic material from the vicinity of the magnetic source.

In a first embodiment, the present invention provides a collection kit for the removal of unwanted material from a surface, said kit comprising:
i) ferromagnetic material to absorb and/or adsorb the unwanted material when spread across the unwanted material creating an area of operation;
ii) an apparatus having a magnetic source operable to attract the ferromagnetic material together with the absorbed and/or adsorbed unwanted material when the magnetic source is touching or in the vicinity of the area of operation; and
iii) a means to dislodge the attracted ferromagnetic material and the absorbed and/or adsorbed unwanted material from the apparatus once the ferromagnetic material has been removed from the area of operation.

The magnetic source itself may simply be a magnet or magnets that are able to directly contact the ferromagnetic material, or be associated with an operable surface that covers the magnetic source with the magnetic source being operable through the operable surface. The operable surface itself may preferably be in the form of a ferromagnetic material when the device is placed near the area of operation. The device would then be operated to remove the attracted ferromagnetic material from the area of operation so that the ferromagnetic material together with the absorbed and/or adsorbed unwanted material is transferred to a collection site. The ferromagnetic material is released from the magnetic source by removing the magnetic source, moving the operable surface to a position away from the magnetic source, or scraping the ferromagnetic material from the magnetic source if the magnetic source has moved with the drum. The ferromagnetic material together with the absorbed and/or adsorbed material is then collected for disposal.

In one embodiment, the magnetic source is generally associated with an operable surface that may itself be magnetised when the magnetic source is touching or in the vicinity of the operable surface. Alternatively, the magnetic source may operate directly to attract the ferromagnetic material. For example, the operable surface itself could move with the magnetic source, for example in a rotating belt like arrangement and essentially the ferromagnetic material, together with the absorbed and/or adsorbed waste material is removed from the operable surface by removing the magnetic source from the operable surface, or removing the operable surface itself. Alternatively, the magnetic source may be in a fixed position while the operable surface rotates around the magnetic source moving the ferromagnetic material to a position away from the fixed magnetic source.

In an alternative embodiment, the operable surface is a collection belt that is fitted on a roller, with magnets located on the inside of the collection belt and able to rotate with the roller. The collection kit is able to be rotated over the unwanted material and ferromagnetic material, which form the area of operation. The collection belt may be moulded silicon or another appropriate material. Any ferromagnetic material attracted to the magnetic source may be dislodged from the operable surface by scraping or brushing the ferromagnetic material from the operable surface when it is rotated to a point away from the area of operation. Once dislodged, the ferromagnetic material, together with any absorbed and/or adsorbed unwanted material may be disposed of in an appropriate manner.

In a preferred embodiment, the drum is a rotating cylinder able to rotate around the bank of magnets that are internal of the drum and have an influence over part of the drum. The magnets are in a position to attract the contaminant-laden ferromagnetic material when the drum is in the vicinity of the area of operation, that is the surface to be cleaned. The ferromagnetic material is released when the drum is rotated to a position where the ferromagnetic material is not in the vicinity of the magnetic source and will be dislodged from the outer surface of the drum.

In one embodiment, the magnetic source may be fixed magnets located within the drum. The magnetic source may be arranged in a concentric wheel or part wheel within the drum and fixed in that position so as to have a magnetic influence over part of the drum. The ferromagnetic material will be attracted to the magnetic source where the magnetic source is operable through the drum and will move with the rotating drum to a location removed from the magnetic influence of the magnetic source. When the ferromagnetic material has reached a point removed from the magnetic source, it will be dislodged from the drum, preferably with the use of a scraper or more simply through gravity or centripetal force.

In a most preferred form the magnets may be arranged so as to assert graduation in the magnetic field, such that the stronger magnetic influence on or through the drum is near the area of operation, that is near the surface to be cleaned. This may be achieved in a number of different ways. In one preferred embodiment, stronger magnets, such as rare earth magnets, are used at or near the area of operation. The stronger magnets here are able to attract a greater proportion of the contaminant-laden ferromagnetic material, and act as lifter magnets.

As the drum is rotated around the bank of magnets, ceramic magnets, which are not as powerful, may be positioned at stations slightly removed from the area of operation. These magnets act as carrier magnets.

As an alternative, or in conjunction, the carrier magnets may simply be positioned further away from the inner surface of the drum. This will assist in reducing the magnetic force and optimise release of the ferromagnetic material from the drum as the drum rotates. That is the lifter magnets will be positioned either touching, or close to the inner surface of the drum, while carrier magnets may also be touching but generally are positioned further away from the inner surface of the drum. It is preferred that there is at least some distance, say at least 2 mm in gap between both the lifter and carrier magnets and the inner surface of the drum. In this embodiment, the magnets may either be of the same or different types of magnets, but preferably different types of magnets.

In a preferred embodiment, the operable surface such as a drum is fitted with cups or fins on its outer surface to assist in trapping and holding the contaminant-laden ferromagnetic material. The cups or fins also assist in releasing the ferromagnetic material when combined with the centripetal force achieved with rotation of the drum. The cups or fins may be in any configuration including being rounded to form a scoop, or angled forward to trap the ferromagnetic material as it lifts it from the surface. In a preferred form, the drum has fins angled at 90° from the surface and of a length of 1 to 50 mm, and spaced 20 to 100 mm apart. It should be appreciated however that other angles, fin sizes and spacing could be used.

In an alternative embodiment, the drum may be a stationary cylinder and the magnetic source is a concentric wheel or part wheel or a bank of magnets internal of the drum that is able to rotate within the drum. The wheel or bank of magnets may be positioned such that it has a magnetic influence over part or the whole of the drum, but is positioned so that it is able to rotate to drive the attracted ferromagnetic material around the surface of the drum until it reaches a point where the ferromagnetic material is dislodged from the surface, preferably with a scraper or the like, or more simply through gravity or centripetal force, where it is collected for disposal purposes or recycle.

In yet a further preferred embodiment, both the drum and magnetic source each rotate. The apparatus may include either a motor or appropriate gearing to drive the outer cylinder and magnetic source in the same direction, or opposite directions. In a preferred embodiment, the drum and inner wheel of magnets will rotate in the same direction, but will be geared to rotate at different rates. It is believed that the speed differential may optimize the efficiency of the pick-up of the ferromagnetic material.

The drum and the concentric inner magnetic source are preferably mounted on a transport means that will allow the apparatus to be moved over the surface to be cleaned. The transport means is preferably a trolley or chassis having its own set of outer driving wheels that will allow the drum or alternative operable surface such as a rotating belt, to be moved across the area of operation. The trolley or chassis serves the purpose of maintaining the drum at an operating height above the ferromagnetic material that has been spread across the surface to be cleaned, such that the magnetic source is able to assert a magnetic influence on the ferromagnetic material and attract it to the outer surface of the drum while still being clear of the material for ease of being able to move the apparatus over the ferromagnetic material. Preferably, the drum is not at a level to touch the ferromagnetic material when spread across the contaminated area, but is at a height just above that level. The trolley or chassis may have means to be able to adjust the height of the outer cylinder in operation.

In a most preferred embodiment, the outer driving wheels of the trolley rotate in the opposite direction to the drum, while the bank of magnets remains fixed. This may be achieved through appropriate gearing between the drum and driving wheels. Rotation of the drum in the opposite direction allows the ferromagnetic material to be released to a collection tray at the back of the trolley. This has the advantage that the collection tray will not interfere with the forward movement of the trolley allowing for greater access to the area to be cleaned.

A preferred gearing arrangement is such that at least one of the outer driving wheels has a gear moulded within the inner surface of that wheel. This gear engages with and turns a one-way bearing. This may include a clutch type arrangement if desired. The one-way bearing turns a smaller gear which rotates the drum in the opposite direction to the outer driving wheels when in a forward motion.

The one-way bearing will allow the drum to spin in one direction only. A brake mechanism is not needed as the friction of the gears will slow the drum as necessary. A clutch type arrangement may be incorporated to allow the drum to spin freely in the same direction (opposite the forward moving driving wheels) or remain stationary. The one-way bearing or clutch arrangement will allow the driving wheels to be able to be moved backward and forward without affecting the rotation of the drum, which will rotate in the one direction only.

Maintaining the reverse direction of the drum will allow the collection kit to continue to pick-up the ferromagnetic material and distribute it to a collection tray which is located at the rear of the trolley. The rotation of the drum should continue in a reverse direction regardless of whether the direction of the driving wheels of the trolley is in a forward or backward direction. This will allow the centripetal momentum of the rotation of the drum to continue allowing continued distribution of the ferromagnetic material to the collection tray at the rear of the trolley.

The speed of the drum or the concentric magnetic source will generally be controlled to maintain the ferromagnetic material on the surface of the drum. The rotational speed of the drum may be generated by the movement of the trolley anywhere from just below walking pace to more high speed, if for example, trailed behind a car or incorporated into a mobile device. The rotational speed may also be controlled by the internal gearing ratios, and may be designed to be variable. The ideal speed of rotation will depend on factors such as the magnetic strength used, and the composition of the ferromagnetic material and the clean-up scenario.

The drum itself may be made from any suitable material that is able to permit the magnetic source to operate through the cylinder and where the material from which the drum is comprised does not itself have any significant affinity for the contaminated material that is to be picked up. Suitable materials include certain plastics, stainless steel and aluminium.

The collection kit includes ferromagnetic material, which is preferably zero valent iron powder or a composite of zero valent iron powder with other powdered magnetic materials such as magnetite or magnetised material. In one preferred form, the iron powder is combined with another material such as a non-magnetic absorbent and/or adsorbent material that will significantly reduce the weight of the ferromagnetic material when compared to iron powder alone, without significant loss of magnetic qualities.

It is preferred that the iron powder particles are spongy grade, but other grades are possible including atomised or annealed particles. The particles themselves may be course, fine or super-fine but preferably have an average particle size of between 5 and 500 microns, preferably between 5 and 200 microns, but most preferably with an average particle size of between 30 to 50 microns. The shape of the particles is preferably irregular and the density, surface features, surface area and porosity may vary depending upon the final intended use. The ferromagnetic material is able to absorb and/or adsorb unwanted materials such as oils, fats, paints, chemicals, abattoir wastes, wine, detergents, and the like. The ferromagnetic material itself may be optimised depending upon the use to which it is likely to be put.

In a further embodiment, the present invention resides in a ferromagnetic material suitable for use with the collection kit of the invention. In this embodiment, the ferromagnetic material is preferably iron powder that has been blended or reacted with a non-magnetic absorbent and/or adsorbent material such that the non-magnetic material is able to integrate with the ferromagnetic material. The non-magnetic absorbent material may be any form of absorbent and/or adsorbent material and could include paper or plastic particles or commercial products including clays and zeolite based products for example, a kitty litter type product. Most preferably, the non-magnetic absorbent material is a zeolite product.

The blending or reacting of the ferromagnetic material with the non-magnetic material may be in any ratio, dependent upon the need. For example it may be in a volume ratio of from 5% to 95% ferromagnetic material with 5% to 95% non-magnetic material, dependent upon the particular application but such that the non-magnetic material is sufficiently integrated with the ferromagnetic material to also be attracted to the magnetic source and achieving an effective contaminant absorption and/or adsorption. Preferably, a relatively even volume ratio of between 40% to 60% of each material is used, and most preferably in an approximately equivalent ratio by volume.

The benefit of blending or reacting a non-magnetic absorbent material is that the ferromagnetic material itself may not satisfactorily pick up oil from a surface. In some circumstances the non-magnetic material, such as zeolite, may not bind sufficiently to the iron powder, even in the presence of oil. It is now considered by the Applicants that the efficiency of blending a non-magnetic material with the ferromagnetic material is improved if the non-magnetic material, such as a zeolite-based product is soaked, for example in a solution of, for example ferric chloride or other salts, so as to impart a charge to the zeolite. Preferably, the zeolite material is soaked in a saturated aqueous solution of ferric chloride for several days for maximum absorption and/or adsorption of ions onto or into the zeolite. A period of anywhere from 12 hours to 5 days may occur, preferably 2 days to 4 days. The resulting material may then be filtered and oven dried at around 50° C. to 70° C. The resultant charge on the non-magnetic material assists it in being integrated with the ferromagnetic material allowing for a consolidated blend such that the blend itself will be attracted to the magnetic source.

It is believed that a modified zeolite of this type has a greater attraction for the surface of the iron particles forming a more coherent blend. For a 50/50 blend of the treated (charged) zeolite with iron powder, a significant improvement in the integrity of the mixture was observed upon oil pick-up. Furthermore, most of the oil could be harvested from this blend.

Further, the zeolite/iron powder blend is significantly lighter than the iron powder alone. A weight reduction of up to 65% may be achieved without significant loss of magnetic character.

The non-magnetic absorbent and/or adsorbent material may take any form and would include such material as absorbent and/or adsorbent clay; zeolites; aluminium silicates and minerals; recycled waste wood products; paper products; grain by-products or other naturally occurring absorbent material such as pelletised corn cobs or wheat grass or straw products. Preferably, the non-magnetic material includes paper, clays and zeolite products. Most preferably the non-magnetic material is a modified zeolite where the characteristics of the zeolite have been modified by soaking the zeolite in a ferric chloride solution or other salts. The particle size of the non-magnetic material depends upon the material which is used but may vary from 5 microns to 100 microns and then blended or reacted with the ferromagnetic material. The blended or reacted material may be subject to grinding to achieve particle-size consistency.

In a most preferred embodiment, the operable surface is a drum, with a bank of fixed magnets within the drum and housed in a trolley. The drum is geared so that it rotates in the opposite direction to the driving wheels of the trolley. Preferably the bank of magnets includes lifter magnets, preferably rare earth magnets at or near the area of operation, and carrier magnets of lesser strength away from the area of operation. The carrier magnets may be magnets that are of a lesser strength such as ceramic magnets, or may simply be positioned further away from the inner surface of the drum creating a lesser magnetic field strength. The carrier magnets allow for easier removal of the ferromagnetic material from the drum, together with the centripetal force of the rotating drum, when the drum is away from the area of operation. A collection basket or tray at the rear of the trolley may be provided to catch the released ferromagnetic material.

The collection device is useful for cleaning up oils and it is anticipated that it will also be useful for cleaning up fats, paints, chemicals, abattoir wastes, wine, detergents or any other material that is able to be adsorbed and/or absorbed by the ferromagnetic material.

### BRIEF DESCRIPTIONS OF THE DRAWINGS

FIG. 1 shows a trolley type device.

FIG. 2 shows the same device from a front orientation.

FIG. 3 shows a cross-sectional view of the Section A-A from FIG. 2.

FIG. 4 shows a side orientation of the trolley type device of FIG. 1.

FIG. 5 illustrates an alternative embodiment that includes a rotating cylinder.

FIG. 6 illustrates an alternative embodiment where cups are included to assist with the transfer of the ferromagnetic material

FIG. 7 illustrates yet an alternative embodiment that includes a stationary cylinder and a rotating wheel of magnets

FIG. 8 illustrates a trolley having a central roller arranged to rotate in the opposite direction to the driving wheels

FIG. 9 illustrates a cross-section of the embodiment of FIG. 8 showing the arrangement of the magnets, driving wheels and drum

FIG. 10 illustrates a gearing mechanism with a one-way bearing

FIGS. 11 to 14 show a blend of the ferromagnetic material together with a modified zeolite demonstrating how the material absorbs and/or adsorbs oil and may be removed by a magnet.

### DETAILED DESCRIPTION OF THE INVENTION

The present invention is described with reference to the accompanying drawings. It is to be understood that these drawings are merely illustrative of preferred embodiments, and the invention as described and claimed herein should not be considered to be limited thereto.

The present invention is illustrated with reference to FIG. 1. In this embodiment, the collection kit consists of ferromagnetic material (1) that has been spread across a surface that is covered with unwanted material. The unwanted material may for example be oil but could be fats, paints, chemicals, abattoir wastes, wine, detergents or any other material able to be adsorbed and/or absorbed by the ferromagnetic material. Spreading the ferromagnetic material over the unwanted material allows for the ferromagnetic material to adsorb and/or absorb the unwanted material.

In a preferred embodiment illustrated with reference to FIG. 1, the apparatus of the kit is a trolley type device having outer driving wheels (2) and handle (3) to allow the trolley to be rolled over unwanted material such as oil spills that have been covered with the ferromagnetic material. The magnetic source includes an operable surface that is a collection belt (4) which is operated by belt wheels (5) (see FIG. 3) to drive and rotate the collection belt.

Ferromagnetic material is placed over the spilled unwanted material to be absorbed and/or adsorbed by the ferromagnetic material. In use, the trolley type device will roll over the ferromagnetic material that has been spread over the unwanted material such that the collection belt operates just above the ferromagnetic material, while the driving wheels (2) run on the surface to be cleaned.

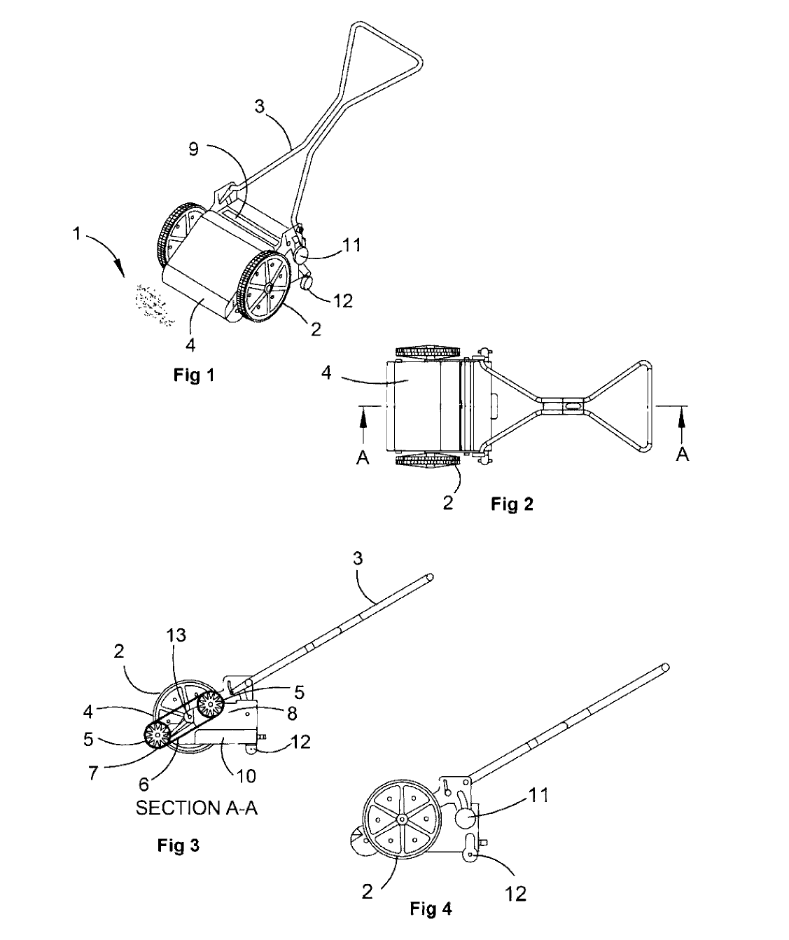

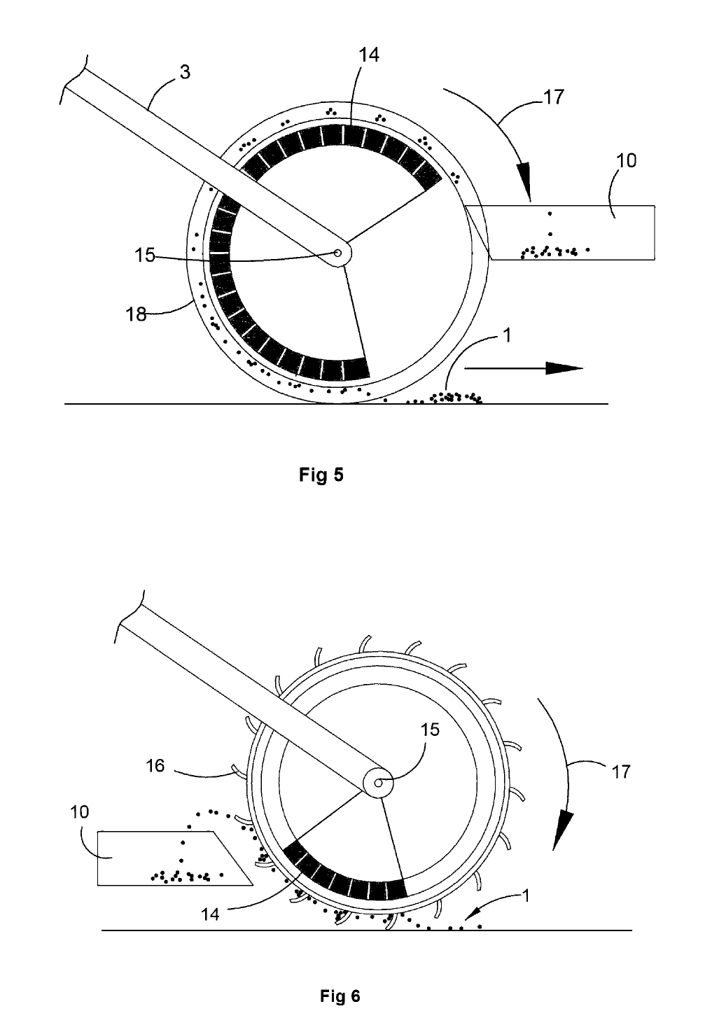

FIG. 2 shows a front view of the trolley type device with line A-A illustrating the cut through section which is illustrated in FIG. 3, and shows the relationship between driving wheels (2) and collection belt (4).

In the cut through illustration of FIG. 3, the magnets (6) can be seen and are affixed to a portion of the collection belt so that approximately a third of the collection belt is magnetically functional. The amount of the collection belt that becomes magnetically functional is simply a matter of design and can vary. The magnets will rotate with the collection belt.

When the magnets are in the lower position (7), they are able to attract the ferromagnetic material that has been spread over the unwanted material (not shown), such as oil, to the collection belt. The ferromagnetic material rotates with the collection belt as the belt wheels and magnets rotate. The ferromagnetic material remains on the collection belt until it reaches Point (8) where cleaning bristles (9) (see FIG. 1) will remove the ferromagnetic material together with the absorbed and/or adsorbed unwanted material which then falls into the collection tray (10). The collection tray is removable for disposal of the ferromagnetic material and waste product.

The collection belt together with the magnets continues to be rotated and collect further ferromagnetic material together with the adsorbed and/or absorbed unwanted material.

The height of the collection belt may be adjusted through the collection belt height adjustor (11). Stability casters (12) may also be provided. There is also a gear box assembly (13) that allows rotation of the main driving wheels to translate the rotation of the belt wheels and hence the rotation of the collection belt.

FIG. 5 shows an alternative embodiment that includes a handle (3) together with a rotating drum (18) and an inner fixed wheel of magnets (14). The drum is able to rotate around axle point (15) while the fixed wheel of magnets remains fixed and so does not rotate when the drum is pushed in a forward motion. The apparatus may include a trolley or chassis (not shown) to maintain the drum at a height just above the surface to be cleaned. The trolley or chassis may have its own set of wheels to allow for the apparatus to be readily rolled over the surface to be cleaned.

The apparatus is able to be rolled over ferromagnetic material (1) such that the ferromagnetic material will be attracted to the magnets and will become fixed to the rotating drum when in the vicinity of the magnets. The drum will rotate in the direction of arrow (17) while the wheel of magnets will remain in a fixed position.

The rotating drum may also be operated to rotate in the opposite direction and at a controlled rotation rate, sufficient to maintain the ferromagnetic material on the surface of the drum. The apparatus may include a motor or gearing mechanism (not shown) to control the direction and rate of rotation of the rotating drum. The ferromagnetic material will be dislodged from the rotating drum when it is no longer in the vicinity of the magnets and will fall into collection tray (10).

A further embodiment is shown in FIG. 6 where the rotating drum (18) includes cups (16) able to assist in collection of the ferromagnetic material. The ferromagnetic material is again dislodged from the rotating drum when no longer in the vicinity of the magnets (14). The magnets remain in a fixed position while the rotating drum is able to rotate in direction of arrow (17) providing a forward motion for the apparatus.

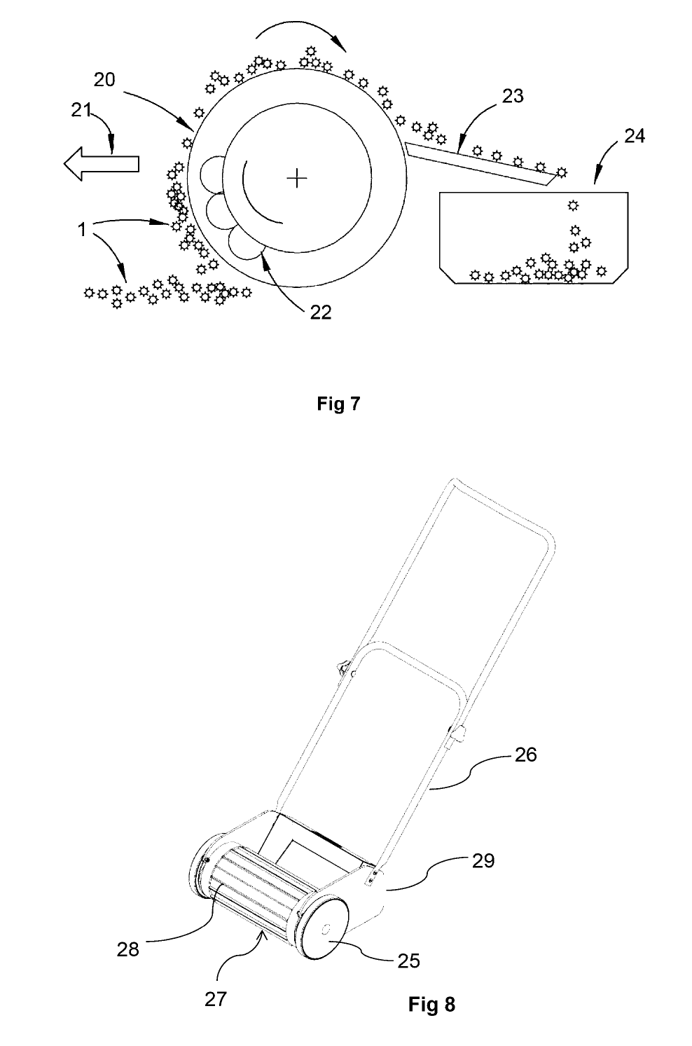

FIG. 7 illustrates an alternative device where the drum (20) is stationary and attached to a trolley or chassis (not shown) having its own wheels to allow the drum to be moved in the direction of arrow (21). The trolley or chassis may be positioned to maintain the drum above the surface to be cleaned. The magnetic source is a wheel of magnets (22) located concentric and internal to the stationary drum. The apparatus may include either a motor or a gearing arrangement to allow the wheel of magnets to rotate in either direction. The wheel of magnets maintains the attracted ferromagnetic material (1) on the surface of the stationary cylinder and guides it around the surface of the drum. The ferromagnetic material is then dislodged from the surface of the drum by scraper (23) into collection basket (24) for disposal.

In a comparable arrangement, both the drum and inner magnetic source may be geared to rotate either in the same direction or in opposite directions and at the same or differing speeds. The apparatus may be designed to allow for variation in the set-up of the movement, both direction and speed, of the drum on the inner concentric magnetic source dependent on the need.

FIG. 8 provides a perspective view of a preferred trolley having outer driving wheels (25) and handle (26) to allow the trolley to be pushed in a forward motion. Drum (27) is geared to rotate in the opposite direction to the driving wheels (25). The drum includes cups or fins (28) to assist in picking up the ferromagnetic material that may be spread over the floor or area of operation. A collection tray (29) is located at the rear of the trolley.

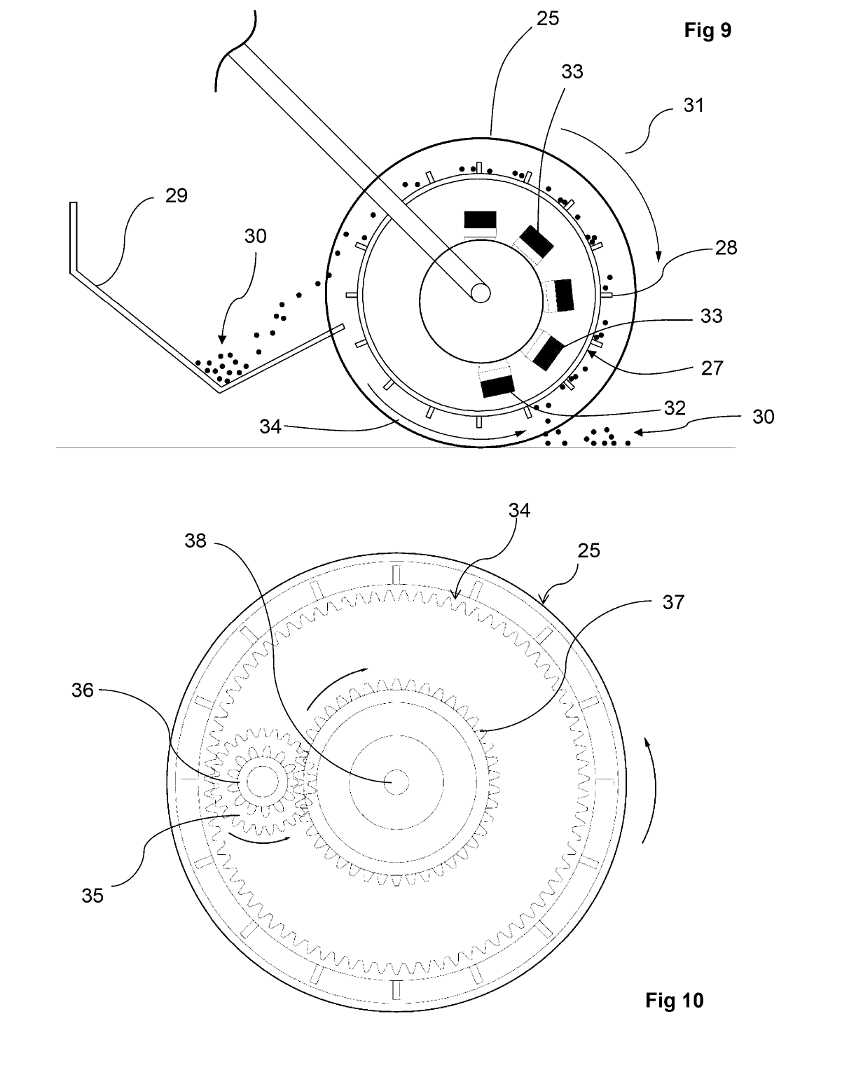

FIG. 9 illustrates the positioning of magnets within the roller (27). Ferromagnetic material (30) is positioned on the area of operation being the surface to be cleaned. The driving wheel (25) rotates in a clockwise direction (31) as illustrated. The magnets are in a fixed position with stronger rare earth lifter magnets (32) positioned near the surface to be cleaned, with ceramic carrier magnets having less strength (33) positioned at positions away from the surface to be cleaned. The drum (27) rotates in an anti-clockwise (34) direction as illustrated.

As an alternative, or in conjunction with different magnet types being used, the magnets themselves may be placed at a graduation of distances from the surface to be cleaned. As illustrated in FIG. 9, the carrier magnets further from the surface to be cleaned are graduated to be a greater distance from the inner surface of the drum at the farthest point from the surface to be cleaned than the lifter magnets at or near the surface to be cleaned.

The ferromagnetic material is picked up at the surface to be cleaned, and is rotated with the assistance of cups or fins (28) to a position away from the surface to be cleaned, where the contaminant-laden ferromagnetic material is then released to collection tray (29), assisted by the centripetal force. The ferromagnetic material (30) may then be disposed of or potentially recycled.

FIG. 10 illustrates a gearing arrangement with outer driving wheel (25) having a gear arrangement (34) on the inner surface of the driving wheel. This gear engages with and rotates a one-way bearing (35). This one-way bearing turns a smaller gear (36) which rotates gear (37) connected to the axis of the drum (38) to rotate the drum in the opposite direction to outer driving wheel (25).

### Example 1

The zeolite used was commercial grade “SpillZorbe”.

The iron powder was supplied by Hoganas AB Grade MH300.29 spongy annealed superfine (average particle size 37 microns).

A quantity of the zeolite material was soaked in a saturated aqueous solution of ferric chloride, FeCl₃, allowing several days for maximum absorption and/or adsorption of ions into the zeolite to occur. The resulting material was then dried in an oven (to constant weight) at around 60° C. This is referred to as the “modified zeolite”.

The modified zeolite was ground to a finer powder using a mortar and pestle and intimately mixed (with stirring) with an equivalent amount (by solid volume) of the iron powder.

A vigorous exothermic solid-state reaction ensued and appeared to be complete after several hours. This reaction appeared to produce two products: (1) a dark, rusty-brown product that is highly magnetic and around 26% lighter than the iron powder (on a solid volume basis) and (2) a dark yellow powder that is slightly magnetic and that is 65% lighter than the iron powder. Due to their differences in magnetic susceptibility, products (1) and (2) could be magnetically separated from one another.

### Example 2

To make a Mark II version that is 50% lighter than the iron powder, product (1) and product (2) from Example 1 were recombined in equivalent proportion by solid volume and the mixture was ground using a mortar and pestle to produce a grey-brown powder. This blend is 50% lighter than the original pure iron powder and appears to be equally effective.

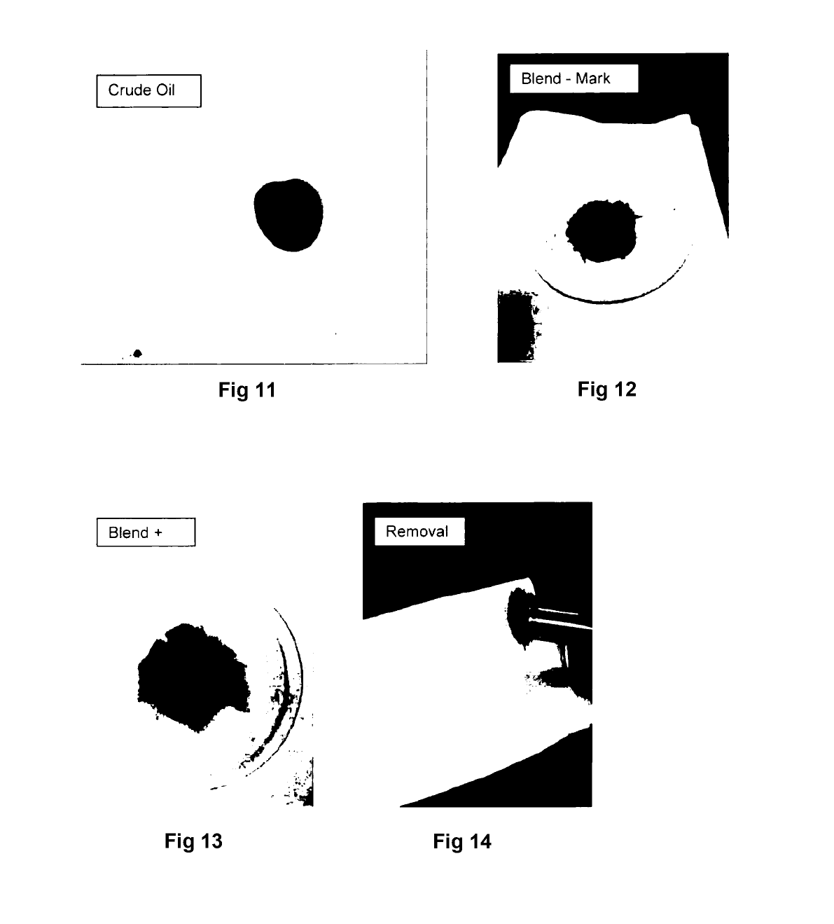

The effectiveness of this blend is shown in FIGS. 11 to 14 where FIG. 11 is crude oil in a petri dish. FIG. 12 illustrates the Mark II blend spread across the crude oil. In time, the ferromagnetic material of Mark II will absorb and/or adsorb the crude oil, as shown in FIG. 13. FIG. 14 demonstrates how ferromagnetic material, with the absorbed and/or adsorbed oil will be attracted to a magnet and removed from the contaminated area.

The invention described herein is illustrative of the invention and provides examples of the best method of performing the invention. The invention described should be considered to be inclusive of minor modifications that may be made without departing from the spirit or ambit of the invention described.

1. A collection kit for the removal of unwanted material from a surface, said kit comprising:
i) ferromagnetic material to absorb and/or adsorb the unwanted material when spread across the unwanted material creating an area of operation;
ii) an apparatus having a drum and a magnetic source arrangement within the drum and operable to attract the ferromagnetic material together with absorbed and/or adsorbed unwanted material to the surface of the drum when the magnetic source is in the vicinity of the area of operation; and
iii) the arrangement of the magnets within the drum allows for the ferromagnetic material to rotate with or around the surface of the drum and be dislodged at an area removed from the area of operation.

2. (canceled)

3. A collection kid according to claim 1 wherein the drum rotates around the magnetic source, the magnetic source being operable through the surface of the drum to attract the ferromagnetic material that is spread across the area of operation.

4. A collection kit according to claim 1 wherein the magnetic source is housed within the drum in a fixed position; the drum operates to rotate around the magnetic source; the magnetic source being arranged to have lifter magnets having a stronger magnetic strength operate near the area of operation to attract the ferromagnetic material to the outer surface of the drum, and carrier magnets providing a lesser magnetic strength positioned away from the area of operation.

5. A collection kit according to claim 3 wherein the lifter magnets are rare earth magnets and the surface of the lifter magnets is located at a distance of from 2 mm to 200 mm, preferably from 10 to 100 mm from the inner surface of the drum when the drum is at or near the area of operation, and the carrier magnets are ferrite ceramic magnets and the surface of the carrier magnets is located at a distance of from 2 to 300 mm, preferably from 10 to 200 mm from the inner surface of the drum when at a distance from the area of operation.

6. A collection kit according to claim 1 wherein either the drum or magnetic source housed within the drum rotate while the other is stationary; or they both rotate in the same or different direction and at the same or different rate; wherein the rotation of both the drum and the magnetic source is controlled by a gearing mechanism.

7. (canceled)

8. A collection kit according to claim 1 wherein the ferromagnetic material is dislodged from the drum by centrifugal force, cleaning bristles or scraping at a location remote from where the magnetic source first attracts the ferromagnetic material.

9. A collection kit according to claim 1 wherein the ferromagnetic material is a zero valent iron particle material or a composite of zero valent iron powder with other powdered magnetic materials such as magnetite, preferably gamma-iron oxide particles, and is blended with a non-magnetic absorbent material, or a non-magnetic absorbent material that has been subsequently magnetized or imparted with an electric charge.

10. A collection kit according to claim 9 wherein the non-magnetic absorbent material is selected from zeolites, absorbent and/or adsorbent clay, aluminium silicates and minerals, recycled waste wood, paper products, grain by-products, plastic particles or other naturally occurring absorbent and/or adsorbent material.

11. (canceled)

12. (canceled)

13. A collection kit according to claim 1 wherein the ferromagnetic material is housed in a container that is able to maintain the temperature of the ferromagnetic material at or above 14° C., and a device to aid in the spreading of the material.

14. (canceled)

15. (canceled)

16. A method of cleaning unwanted material from a surface, said method comprising the steps of:
(i) spreading and mixing a ferromagnetic material on or across the unwanted material creating an area of operation, the ferromagnetic material being able to preferentially absorb and/or adsorb the unwanted material;
(ii) collecting the ferromagnetic material with an apparatus having a drum and a magnetic source arranged within the drum and operable to attract the ferromagnetic material together with the absorbed and/or adsorbed unwanted material, when the magnetic source is in the vicinity of the area of operation; and
(iii) magnets within the drum allows for the ferromagnetic material to be rotated with or around the surface of the drum to a position to dislodge the ferromagnetic material for disposal or recycle.

17. A method according to claim 16, wherein the unwanted material includes oils, fats, chemicals, paints, abattoir wastes, wine, detergents and/or any material able to be adsorbed or absorbed by the ferromagnetic material.

18. A ferromagnetic material, suitable for use with the collection kit of claim 1, including a ferromagnetic material, preferably zero valent iron powder or a composite of zero valent iron powder with other powdered magnetic material, together with a non-magnetic absorbent and/or adsorbent material.

19. A ferromagnetic material according to claim 18 wherein the iron particles are spongy grade, atomised or annealed particles having an average particle size of between 5 and 100 microns, but most preferably with an average particle size of between 30 to 50 microns.

20. A ferromagnetic material according to claim 18 wherein the non-magnetic absorbent and/or adsorbent material is selected from zeolites, absorbent and/or adsorbent clays, aluminium silicates and minerals, recycled waste wood products, paper products, grain by-products, plastic particles or naturally occurring absorbent and/or adsorbent material.

21. A ferromagnetic material according to claim 18 where the non-magnetic absorbent and/or adsorbent material is a modified zeolite product that has been soaked in ferric chloride or other salts to impart a charge on the zeolite.

22. A ferromagnetic material according to claim 18 wherein the modified zeolite is soaked in an aqueous ferric chloride solution for up to 5 days, preferably between 1 day and 4 days, to impart a charge on the zeolite.

23. A ferromagnetic material according to claim 18 wherein the non-magnetic absorbent material is blended or reacted with the ferromagnetic material in a ratio of 5:95 wt. % to 95:5 wt. %, preferably 40:60 wt. % to 60:40 wt. % and most preferably 50:50 wt. % to form a composite material or product that is able to be attracted to the magnetic source.

24. A collection kit according to claim 4 when the lifter magnets at or near the area of operation have a magnetic strength of from 1,000 to 15,000 Gauss, preferably 1500 to 10,000 Gauss at their surface and the carrier magnets which are placed at a distance from the area of operation have a magnetic strength of 100 to 5,000 Gauss, preferably 500 to 3,000 Gauss at their surface.

25. A collection kit according to any one of claim 1 wherein the drum is positioned to operate at 5 to 50 mm, preferably 10 to 30 mm above the surface of the area of operation, and includes cups or fins on its surface to assist in lifting and carrying the ferromagnetic material.

26. A collection kit according to any one of claim 1 further including a trolley having driving wheels to move the trolley in a forward or backward direction, and including gearing mechanism to control the rotation of the drum such that it rotates in the opposite direction to the driving wheels when the collection kit is moved in a forward direction and remains stationary when the trolley is moved backwards; or is geared such that the drum will continue to rotate in the opposite direction from the driving wheels regardless of whether the driving wheels are moved in a forward or backward direction.
